(19) United States
(12) Patent Application Publication
(10) Pub. No.: US 2008/0034911 A1
(43) Pub. Date: Feb. 14, 2008

(54) Device for Pressing on a Steering Rack

(76) Inventors: Juergen Bieber, Pluederhausen (DE); Werner Breitweg, Bargau (DE); Jens-Uwe Hafermalz, Waeschenbeuren (DE); Hermann Ocker, Schwaebisch Gmuend (DE); Jochen Schmid, Alfdorf-Rienharz (DE)

Correspondence Address: KENYON & KENYON LLP, ONE BROADWAY, NEW YORK, NY, 10004, US

(21) Appl. No.: 11/667,169

(22) PCT Filed: Oct. 28, 2005
(86) PCT No.: PCT/EP05/55621

§ 371 Date: Oct. 19, 2007

(30) Foreign Application Priority Data
Nov. 5, 2004 (DE) 10 2004 053 462.4

(51) Int. Cl. F16H 55/28; B62D 3/12

(52) U.S. Cl. 74/422

(57) ABSTRACT

In a device for pressing a steering rack against a pinion, having a thrust member and a setting element, it is provided that the thrust member and the setting element each have contact faces aligned with one another which, in a basic position, abut against each other, at least one of the contact faces being flexible. The thrust member has a thrust-member body and a pin which projects in the direction of the setting element and whose exposed end takes the form of a contact face. The setting element has at least a two-part configuration, made up of an adjusting screw and a spring washer. The spring washer is disposed between the adjusting screw and the thrust member, and forms the contact face for the exposed end of the pin.

### FIELD OF THE INVENTION

The present invention relates to a device for pressing a steering rack against a pinion, having a thrust member and a setting element.

### BACKGROUND INFORMATION

A device of this type is described in German Published Patent Application No. 198 11 917.

Rack-and-pinion steering systems for motor vehicles normally have a steering-gear housing, in which a steering rack is supported so as to be longitudinally displaceable. A pinion rotationally mounted in the steering-gear housing meshes with the toothing of the steering rack and causes the steering rack to be laterally displaced in response to the rotation of the steering column connected to the pinion in a rotatably fixed manner. The steering rack, in turn, causes the steered wheels of the motor vehicle to swivel via tie rods and steering knuckles. The engagement of the pinion with the steering rack is kept free from play in that a thrust member opposite the pinion and abutting against the steering rack under spring preloading presses the steering rack against the pinion. It is conventional that the play of the thrust member is adjusted via an adjusting screw, which at the same time also influences the spring preloading.

The thrust member must be designed such that, or must press against the steering rack such that, a coupling of the steering rack and the pinion can be maintained without play in the meshing teeth. In this context, imperfections with respect to the eccentricity of the pinion, its axial play, and the wear of the teeth must be taken into account. In addition, the mechanism must be capable of enduring shocks coming from the steered wheels when, for example, they strike an obstacle, without damage.

German Published Patent Application No. 198 11 917 describes a thrust member and a setting element for pressing a steering rack against a pinion, in which a spring is disposed between the thrust member and the setting element. In this case, the spring is supported on the setting element and presses the thrust member against the steering rack, which consequently is pressed against the pinion. The spring force with which the spring presses the thrust member against the steering rack can be varied by adjusting the setting element.

A disadvantage is that knocking noises develop because of the high gearing forces in electromechanical steering systems. Moreover, the spring force changes over the service life. The play of the thrust member also changes due to wear, which makes it necessary to readjust the thrust-member play.

### SUMMARY

Example embodiments of the present invention provide a device for pressing a steering rack against a pinion, having a thrust member and a setting element, which eliminates disadvantages such as those described above, in particular avoids knocking noises, and is able to be produced and assembled inexpensively.

Because the contact faces of the thrust member and the setting element abut against each other in a basic position, no noises come about due to a contacting of the contact face of the thrust member and the contact face of the setting element. To be understood by basic position is that no dynamic forces or forces due to the engagement of the pinion with the steering rack are acting which are capable of shifting the steering rack in the direction of the thrust member.

Because at least one of the contact faces is flexible, a zero-play toothing engagement is provided, even when turning around with great steering speeds. This zero-play toothing engagement reduces the generation of noise when turning around. The flexibility of the contact faces may also be complemented by the use of a compression spring which may be inserted between the thrust member and the setting element.

The thrust member may have a thrust-member body and a pin which projects in the direction of the setting element and whose exposed end takes the form of a contact face. The setting element has a two-part construction made up of an adjusting screw and a spring washer. In the basic position, the spring washer is disposed between the adjusting screw and the thrust member, and forms the contact face for the exposed end of the pin.

The durability for such devices is attained due to the two-part construction of the setting element. In addition, it is possible to dispense with a costly surface coating as corrosion protection for the adjusting screw. The setting element may be produced inexpensively and precisely by a two-part construction formed of an adjusting screw and a spring washer.

It may be provided that in the basic position, the spring washer is deflected by the pin. This counteracts a wear or settling process occurring over the lifetime of the device. By preloading the spring washer, the exposed end of the pin still abuts against the spring washer even if, for example, the pinion has deteriorated because of wear. Therefore, annoying noises are avoided even after wear.

The pin may also be flexible.

The play of the thrust member can easily be readjusted. This may be accomplished simply by a further screwing-in or screwing-back of the adjusting screw. In this context, the adjusting screw may be provided with an opening through which, for example, the deformation of the spring washer may be measured or checked based on displacement measurements.

Therefore, a precise adjustment of the thrust-member play or of the thrust member is possible.

The pin may project, e.g., 0.6 mm beyond a contact surface of the thrust-member body facing the setting element. At the same time, it is provided that the spring washer is pressed or deflected, e.g., 0.5 mm by the pin. The distance between the contact surface of the thrust-member body and the spring washer or the adjusting screw (depending upon which element projects further in the direction of the thrust member or lies opposite the contact surface) is therefore, e.g., 0.1 mm. This distance represents the play of the thrust member.

The device may exhibit a long service life accompanied by unaltered effectiveness. If necessary, the play of the thrust member may be readjusted. In contrast to the device described in German Published Patent Application No. 198 11 917, the device hereof is not sensitive to temperature fluctuations. It may be provided that the thrust-member body is formed as an aluminum die-cast part, and the pin is integrally cast. It also may be provided that the spring washer, which is subject to a constant alternating load during operation, is made of a high-quality spring steel having great stability. For example, the spring washer may take the form of a flat stamped metal part and be manufactured very precisely. A tolerance-insensitive spring characteristic is thereby achieved. This is an important advantage compared to uneven cup springs. The adjusting screw may be produced as a corrosion-resistant die-cast part, e.g., from a zinc die casting. If the use of a compression spring is provided, it may be implemented as a metallic spiral spring.

At its end face facing the thrust member, the adjusting screw may have a bearing surface for placing or positioning the spring washer. At the same time, the adjusting screw may have a centering collar for the radial positioning of the spring washer. The centering collar and the bearing surface may be adapted to the thickness and the shape of the spring washer. Therefore, the spring washer may be disposed in especially simple manner between the adjusting screw and the thrust member.

The spring characteristic may be influenced easily by the bearing surface. The bearing surface may be implemented in any form as needed for influencing the spring characteristic. For example, it may be provided that the bearing surface extends parallel and/or at an angle with respect to the spring washer. The bearing surface may also have a rounding or be provided with a radius.

To produce a progressive spring characteristic, the contact face of the pin may also be cambered.

Example embodiments of the present invention are described in more detail below with reference to the appended Figures.

### BRIEF DESCRIPTION OF THE DRAWINGS

FIG. 1 is a cross-sectional view through a device according to an example embodiment of the present invention in a basic position in a form in which the pin of the thrust member deflects the spring washer.

FIG. 2 is a perspective cross-sectional view through a setting element having an adjusting screw and a spring washer.

FIG. 3 is a cross-sectional view through the setting element illustrated in FIG. 2.

FIG. 4 is a top view of the setting element taken along direction IV illustrated in FIG. 3.

FIG. 5a is a view of one possible formation of a bearing surface of the adjusting screw.

FIG. 5b is view of a formation of the bearing surface as an alternative to that illustrated in FIG. 5a.

FIG. 6 is a perspective cross-sectional view of the thrust member having a thrust-member body and an integrally cast pin.

FIG. 7 is a cross-sectional view of the thrust member having a thrust-member body and a pin formed independently thereof and joined to the thrust-member body.

FIG. 8 illustrates a spring characteristic (preload force/spring excursion).

### DETAILED DESCRIPTION

Rack-and-pinion steering gear, e.g., for motor vehicles, having thrust members for coupling a steering rack against a pinion are described, for example, in German Published Patent Application No. 29 28 732 and German Published Patent Application No. 198 11 917. Therefore, only the relevant features hereof are discussed in greater detail below.

The basic principle of such a coupling mechanism for a steering rack and its driving pinion is sufficiently understood from the general related art and from the documents mentioned above.

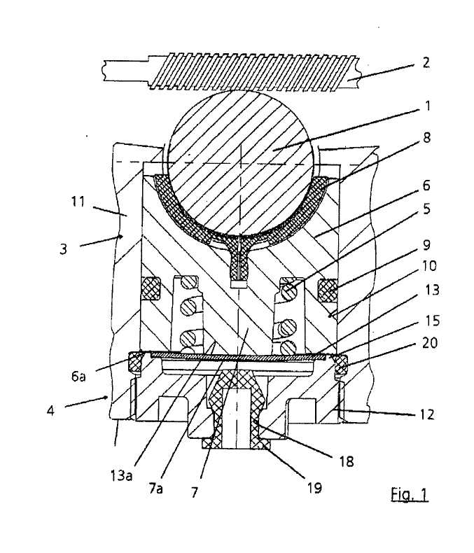

As FIG. 1 shows, the device of an example embodiment of the present invention for pressing a steering rack 1 against a pinion 2 has a thrust member 3 and a setting element 4. A spring element in the form of a compression spring 5 is disposed between thrust member 3 and setting element 4.

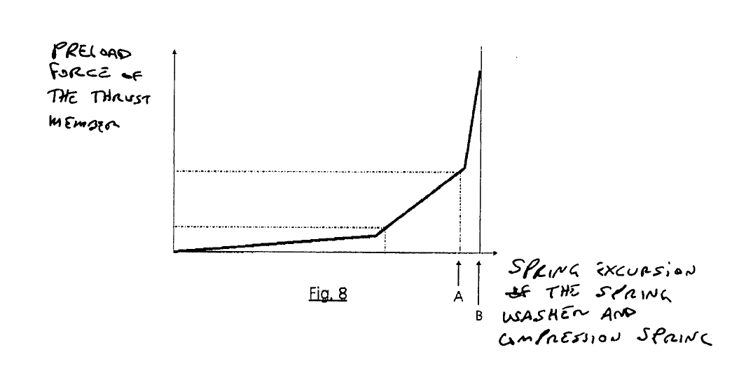

As apparent especially from FIG. 1 and FIG. 7, thrust member 3 has a thrust-member body 6, a pin 7, an insert foil 8 and an O-ring 9. As illustrated in FIGS. 1 and 6, pin 7 is formed in one piece with thrust-member body 6. In the exemplary embodiment illustrated, thrust-member body 6 is formed from an aluminum die-cast part with integrally cast pin 7. FIG. 7 illustrates a construction in which pin 7 is implemented independently of thrust-member body 6. This can be advantageous in the case of high compressive load per unit area and high pin wear. As illustrated in FIG. 7, pin 7 is made of steel (e.g., as a steel pin).

As FIG. 1 illustrates, compression spring 5 takes the form of a spiral spring disposed substantially within a hollow space formed by thrust-member body 6.

To reduce wear, it is provided in the exemplary embodiment illustrated to implement thrust-member body 6 and pin 7 with a surface coating (e.g., anodization).

Pin 7 extends coaxially with respect to the axis of thrust member 3 or thrust-member body 6.

As illustrated in FIG. 1, thrust member 3 is situated in a locating space 10 of a steering-gear housing 11. Locating space 10 in steering-gear housing 11 is usually formed as a cylindrical bore, the circumference of thrust-member body 6 or the outside diameter of thrust-member body 6 being adapted substantially to the inside diameter of locating bore 10.

In the exemplary embodiment illustrated, the end of thrust-member body 6 facing steering rack 1 is provided with a, e.g., conventional, low-friction insert foil 8. Insert foil 8 (which may also be referred to as sliding foil) is used as a bearing for steering rack 1. On one hand, insert foil 8 makes it possible for thrust-member body 6 to transfer the necessary pressure force. On the other hand, insert foil 8 provides that no significant frictional forces and no wear and tear is produced during displacement of steering rack 1.

Reference is made to German Published Patent Application No. 103 09 303 with regard to an exemplary form of insert foil 8.

As FIG. 1 further illustrates, locating bore 10 is closed at its opening facing away from steering rack 1 by setting element 4. Setting element 4 has an adjusting screw 12 and a spring washer 13. In the exemplary embodiment illustrated, setting element 4 substantially takes the form of a two-part assembly. Adjusting screw 12 and spring washer 13 are components independent of each other. Adjusting screw 12 is implemented as a corrosion-resistant zinc die-cast part and may be screwed in defined manner into locating bore 10.

Spring washer 13 is disposed between adjusting screw 12 and thrust member 3. Spring washer 13 forms contact face 13a for the exposed end of pin 7, i.e., for contact face 7a. In the exemplary embodiment illustrated, spring washer 13 is deflected, e.g., 0.5 mm by the exposed end of pin 7. In this context, the pin projects, e.g., 0.6 mm beyond thrust-member body 6 in the direction of setting element 4. Therefore, in the basic position, the distance between spring washer 13 or adjusting screw 12 and a facing contact surface 6a of thrust-member body 6 is, e.g., 0.1 mm. The so-called thrust-member play (between contact surface 6a and spring washer 13) is therefore, e.g., 0.1 mm. The thrust-member play represents the maximum mobility of thrust member 3 in the direction of setting element 4.

In the exemplary embodiment illustrated, spring washer 13 takes the form of a flat stamped metal part. Alternatively, spring washer 13 may also be produced precisely, e.g., by surface grinding. Spring washer 13 is made of a high-quality spring steel with great stability.

As illustrated in FIGS. 1 to 5b, at its end face facing thrust member 3, adjusting screw 12 has a bearing surface 14 for the positioning of spring washer 13. Bearing surface 14 forms a ring-shaped bearing surface for spring washer 13. Spring washer 13 is supported by bearing surface 14 in the area of its periphery, so that spring washer 13 is not able to give way in this area. The inner region, that is, the entire remaining area of spring washer 13 with the exception of the periphery resting on bearing surface 14, is freely suspended, i.e., does not rest on adjusting screw 12, so that this area is able to sag, that is, can be deflected. Since pin 7, which deflects spring washer 13, is disposed coaxially with respect to thrust-member body 6, a deflection of spring washer 13 is achieved. As illustrated in FIGS. 1 to 5b, adjoining bearing surface 14 is a centering collar 15 which radially positions spring washer 13. Bearing surface 14 and centering collar 15 permit a simple fixation of the position of spring washer 13 relative to adjusting screw 12.

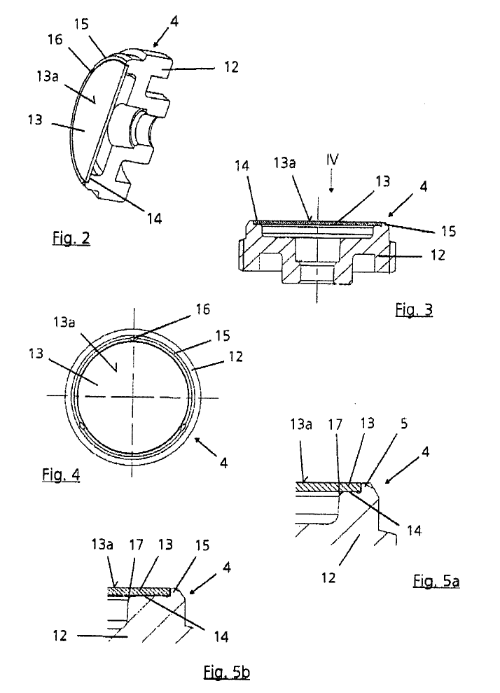

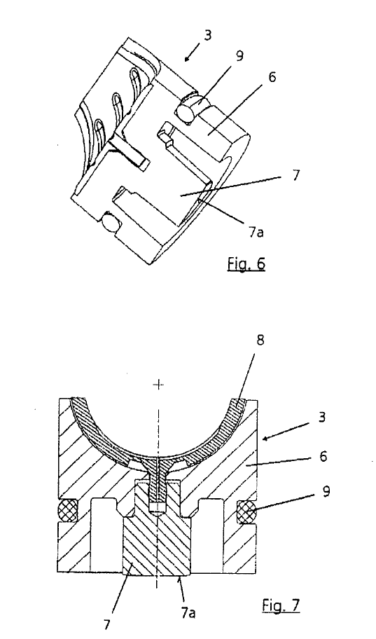

As illustrated in FIG. 2 and FIG. 4, spring washer 12, especially to secure for transport, may be joined to adjusting screw 12 by localized caulking points 16. Three localized caulking points 16 are provided in the exemplary embodiment illustrated.

The spring characteristic illustrated in FIG. 8 may be influenced by the profile of bearing surface 14. FIG. 5a illustrates one profile of bearing surface 14, in which roundings 17 are provided. FIG. 5b illustrates a profile of bearing surface 14 at an angle with respect to spring washer 13. In principle, spring washer 13 may also have a rounding or an oblique profile in the area of bearing surface 14, but this is not favored in view of convenient production of spring washer 13.

As FIGS. 1 to 3 illustrate, adjusting screw 12 has an opening 18, through which the thrust member may be adjusted precisely via displacement measurement. In the exemplary embodiment illustrated, opening 18 is closed by a sealing element 19 in the form of a sealing plug.

In addition, FIG. 1 illustrates an O-ring 20 which provides a seal between adjusting screw 12 and steering-gear housing 11.

FIG. 8 illustrates a spring characteristic of the preload force of the thrust member, and of the spring excursion of the spring washer and of compression spring 5. In this context, point A denotes a possible readjustment, while point B represents the limit stop as a result of the thrust-member play.

For example, depending upon the coordination, spring washer 13 may have a thickness of, e.g., 0.5 mm to 1.2 mm, e.g., 0.8 mm. The spring rate in the exemplary embodiment illustrated is, e.g., 1000 N/mm.

The design approach hereof may be suitable for rack-and-pinion steering systems for motor vehicles, but is not limited to them. The device may also be used for rack-and-pinion steering systems in other fields.

### REFERENCE NUMERALS

1 steering rack
2 pinion
3 thrust member
4 setting element
5 compression spring
6 thrust-member body
6a contact surface
7 pin
7a contact face
8 insert foil
9 O-ring of thrust member
10 locating space
11 steering-gear housing
12 setting element
13 spring washer
13a contact face
14 bearing surface
15 centering collar
16 caulking point
17 rounding
18 opening
19 sealing element
20 O-ring of housing

1-20. (canceled)

21. A device for pressing a steering rack against a pinion, comprising:
a thrust member having a thrust-member body and a pin, an exposed end of the pin forming a contact face; and
a setting element having at least a two-part configuration and including an adjusting screw and a spring, the pin projecting in a direction of the setting element, the spring arranged as a flat spring washer and arranged between the adjusting screw and the thrust member, the spring forming a contact face aligned with the contact face of the pin;
wherein the contact faces are configured to abut against each other in a basic position, at least one of the contact faces being flexible;
wherein, to provide spring action, an end face of the adjusting screw facing the thrust member includes a ring-shaped bearing surface configured for placement of the spring washer and to support the spring washer in an area of a periphery of the spring washer, an inner area of the spring washer forming the contact face not resting on the adjusting screw and being deflectable; and
wherein, in the basic position, the spring washer is deflected by the pin.

22. The device according to claim 21, wherein the pin extends coaxially with respect to an axis of the thrust member.

23. The device according to claim 21, wherein the pin projects at least one of (a) 0.3 mm to 0.8 mm and (b) 0.6 mm beyond a contact surface of the thrust-member body facing the setting element.

24. The device according to claim 21, wherein the spring washer is deflected by 0.5 mm.

25. The device according to claim 23, wherein the contact surface of the thrust-member body facing the setting element and one of (a) the spring washer and (b) the adjusting screw are at a distance to each other in the basic position.

26. The device according to claim 21, wherein at least one of (a) the thrust-member body and (b) the pin includes a surface coating.

27. The device according to claim 21, wherein the pin is integral with the thrust-member body.

28. The device according to claim 27, wherein the thrust-member body is arranged as an aluminum die-cast part and the pin is integrally cast with the thrust-member body.

29. The device according to claim 21, wherein the pin is formed independently of the thrust-member body and is joinable to the thrust-member body.

30. The device according to claim 29, wherein the pin is made of steel.

31. The device according to claim 21, wherein the thrust member includes a low-friction insert foil.

32. The device according to claim 21, wherein the adjusting screw is made of at least one of (a) a corrosion-resistant die-cast part and (b) a zinc die-cast part.

33. The device according to claim 21, wherein the spring washer is arranged as a flat stamped metal part.

34. The device according to claim 21, wherein the adjusting screw includes a centering collar configured to radially position the spring washer.

35. The device according to claim 21, wherein the spring washer is joined to the adjusting screw by localized caulk points.

36. The device according to claim 21, wherein the ring-shaped bearing surface is arranged at least one of (a) parallel and (b) at an angle with respect to the spring washer.

37. The device according to claim 21, wherein the ring-shaped bearing surface includes roundings.

38. The device according to claim 21, wherein the adjusting screw includes an opening configured for measurement of deflection of the spring washer.
